(19) United States
(12) Patent Application Publication
(10) Pub. No.: US 2018/0194332 A1
(43) Pub. Date: Jul. 12, 2018

(54) Brake Control Apparatus and Brake System

(71) Applicant: Hitachi Automotive Systems, Ltd., Hitachinaka-shi, Ibaraki (JP)

(72) Inventor: Asahi WATANABE, Kawasaki-shi, Kanagawa (JP)

(21) Appl. No.: 15/741,788

(22) PCT Filed: May 19, 2016
(86) PCT No.: PCT/JP2016/064850

§ 371 Date: Jan. 4, 2018

(30) Foreign Application Priority Data
Jul. 7, 2015 (JP) 2015-135720

(51) Int. Cl. B60T 8/17; B60T 13/16; B60T 8/34; B60T 8/48; B60T 13/68

(52) U.S. Cl. CPC B60T 8/17; B60T 13/161; B60T 8/341; B60T 8/48; B60T 7/12; B60T 2201/03; B60T 2270/10; B60T 2270/306; B60T 13/686

(57) ABSTRACT

Provided is a brake control apparatus and a brake system capable of improving reliability of a performance of holding a hydraulic pressure in a wheel cylinder. A brake control apparatus includes a first valve provided in a first oil passage connecting a hydraulic source configured to supply brake fluid to a wheel cylinder and the wheel cylinder to each other, a return flow oil passage connected to the first oil passage between the hydraulic source and the first valve and configured to return the brake fluid supplied from the hydraulic source to a low-pressure portion, a pressure adjustment valve provided in the return flow oil passage and configured to adjust a brake hydraulic pressure in the first oil passage, and a hydraulic holding portion configured to hold a hydraulic pressure in the wheel cylinder set by a brake hydraulic pressure supplied from the hydraulic source to the wheel cylinder by activating the pressure adjustment valve and the first valve in respective valve-closing directions.

### TECHNICAL FIELD

The present invention relates to a brake control apparatus and a brake system that apply a braking force to a wheel, and, in particular, to a braking control apparatus that electronically controls the braking force.

### BACKGROUND ART

For example, there is known a brake apparatus that controls a brake fluid amount to be guided to a wheel cylinder with use of a hydraulic source and a flow amount control electromagnetic valve, thereby adjusting a braking force, as disclosed in PTL 1. Further, there is known a brake apparatus that stops an operation of the hydraulic source and closes the flow amount control electromagnetic valve when a hydraulic pressure in the wheel cylinder should be maintained with a vehicle stopped, thereby improving a power saving performance and system durability, as disclosed in PTL 2.

It can be easily concluded that, for the brake apparatus that adjusts the wheel cylinder pressure with use of the hydraulic source and the flow amount control electromagnetic valve, like the disclosure of PTL1, the power saving performance and the durability would also be able to be improved by stopping the operation of the hydraulic source and closing the flow amount control electromagnetic valve to thus maintain the hydraulic pressure when the hydraulic pressure in the wheel cylinder should be maintained even with the vehicle stopped.

### CITATION LIST

### Patent Literature

PTL 1: Japanese Patent Application Public Disclosure No. 2000-344080

PTL 2: International Publication No. 2013/002168

### SUMMARY OF INVENTION

### Technical Problem

However, the method that stops the hydraulic source and closes the flow amount control electromagnetic valve while the vehicle is stopped involves a problem in light of reliability of a holding performance. More specifically, this method involves the following problem. For example, when a valve-opening abnormality has occurred due to an abnormality in an operation of the flow amount control electromagnetic valve or when a leak has occurred due to a mechanical abnormality in the hydraulic source, a vehicle braking force may reduce with a failure to continue holding the wheel cylinder pressure. If the abnormality has occurred on a hill, the vehicle may start moving, thereby causing a driver to feel anxiety and discomfort.

The present invention has been made in consideration of the above-described problem, and an object thereof is to provide a brake control apparatus and a brake system capable of improving the reliability of the performance of holding the hydraulic pressure in the wheel cylinder.

### Solution to Problem

To achieve the above-described object, a brake control apparatus according to a first aspect of the present invention includes a first valve provided in a first oil passage connecting a hydraulic source configured to supply brake fluid to a wheel cylinder and the wheel cylinder to each other, a return flow oil passage connected to the first oil passage between the hydraulic source and the first valve and configured to return the brake fluid supplied from the hydraulic source to a low-pressure portion, a pressure adjustment valve provided in the return flow oil passage and configured to adjust a brake hydraulic pressure in the first oil passage, and a hydraulic holding portion configured to hold a hydraulic pressure in the wheel cylinder set by a brake hydraulic pressure supplied from the hydraulic source to the wheel cylinder by activating the pressure adjustment valve and the first valve in respective valve-closing directions.

A brake control apparatus according to a second aspect of the present invention includes a first valve provided in a first oil passage connecting a hydraulic source configured to supply brake fluid to a wheel cylinder and the wheel cylinder to each other, a pressure adjustment oil passage connected to the first oil passage between the hydraulic source and the first valve and connected to a low-pressure portion, a pressure adjustment valve provided in the pressure adjustment oil passage in series with the first valve, and a hydraulic holding portion configured to hold a hydraulic pressure in the wheel cylinder set by a brake hydraulic pressure supplied from the hydraulic source to the wheel cylinder by activating the pressure adjustment valve and the first valve in respective valve-closing directions.

A brake system according to a third aspect of the present invention includes a primary system oil passage connecting a primary hydraulic chamber of a master cylinder and a wheel cylinder belonging to the primary system to each other, a secondary system oil passage connecting a secondary hydraulic chamber of the master cylinder and a wheel cylinder belonging to the secondary system to each other, a connection oil passage connecting the primary system oil passage and the secondary system oil passage to each other, a hydraulic source connected to the connection oil passage and configured to supply brake fluid to the corresponding wheel cylinder via each of the primary and second system oil passages, a first communication valve provided between the connection oil passage and the primary system oil passage, a second communication valve provided between the connection oil passage and the secondary system oil passage, a pressure reduction oil passage connecting the connection oil passage and a low-pressure portion to each other, a pressure adjustment valve provided in the pressure reduction oil passage, and a hydraulic holding portion configured to hold a brake hydraulic pressure supplied from the hydraulic source to the corresponding wheel cylinder by controlling each of the first and second communication valves and the pressure adjustment valve in respective valve-closing directions.

Therefore, the present invention can improve the reliability of holding the hydraulic pressure in the wheel cylinder.

### BRIEF DESCRIPTION OF DRAWINGS

FIG. 1 schematically illustrates a configuration including a hydraulic circuit regarding a brake apparatus according to a first embodiment.

FIG. 2 is a control block diagram of an electronic control unit according to the first embodiment.

FIG. 3 is a flowchart illustrating a flow of processing for determining a control mode according to the first embodiment.

FIG. 4 is a flowchart illustrating a flow of control processing in a vehicle stop holding control mode according to the first embodiment.

FIG. 5 is a timing chart illustrating how an operation proceeds until the vehicle is stopped according to the first embodiment.

FIG. 6 is a flowchart illustrating a flow of control processing in the vehicle stop holding control mode according to the first embodiment.

FIG. 7 is a timing chart illustrating how the operation proceeds until the vehicle is stopped according to the first embodiment.

FIG. 8 is a timing chart illustrating how the operation proceeds until the vehicle is stopped according to a second embodiment.

FIG. 9 schematically illustrates the configuration including the hydraulic circuit regarding a brake apparatus according to a third embodiment.

FIG. 10 schematically illustrates the configuration including the hydraulic circuit regarding a brake apparatus according to a fourth embodiment.

FIG. 11 schematically illustrates the configuration including the hydraulic circuit regarding a brake apparatus according to a fifth embodiment.

### DESCRIPTION OF EMBODIMENTS

In the following description, embodiments for realizing a brake apparatus according to the present invention will be described based on an exemplary embodiment illustrated in the drawings.

### First Embodiment

### [Configuration of Brake Apparatus]

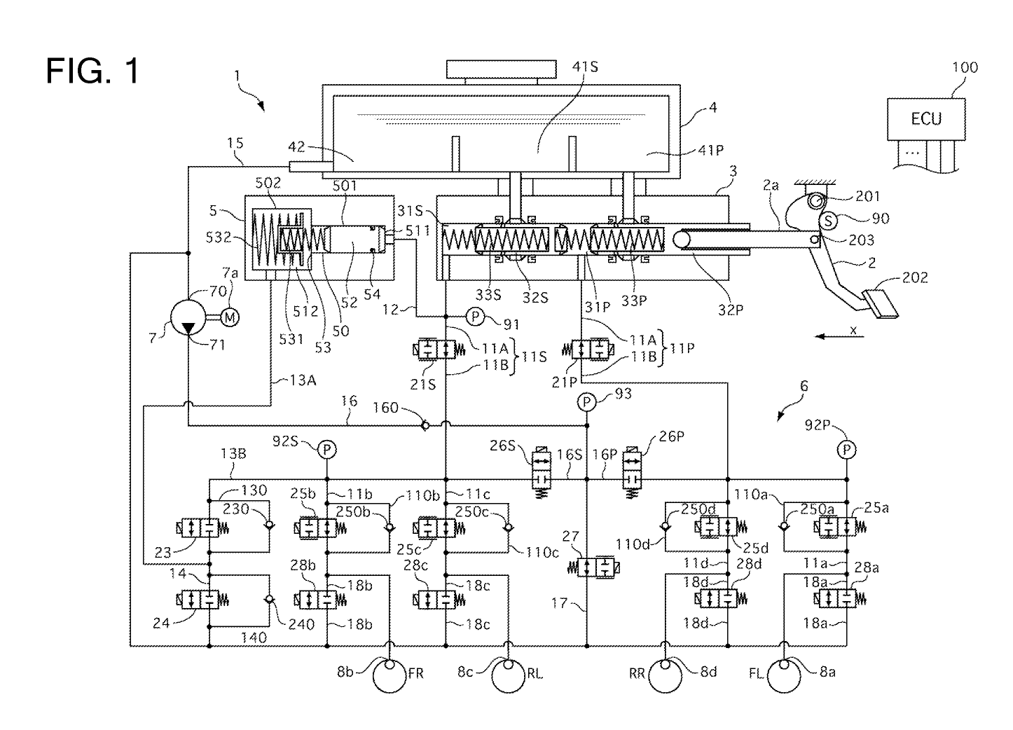

First, a configuration of a brake hydraulic circuit will be described. FIG. 1 schematically illustrates a configuration including a hydraulic circuit regarding a brake apparatus 1 (a brake system) according to a first embodiment. The brake apparatus 1 is a hydraulic brake apparatus preferably usable for an electric vehicle. The electric vehicle is, for example, a hybrid automobile including a motor generator (a rotational electric machine) besides an engine (an internal combustion engine) or an electric automobile including only the motor generator, as a prime mover for driving wheels. The brake apparatus 1 may also be applied to a vehicle using only the engine as the driving force source.

The brake apparatus 1 supplies brake fluid into a wheel cylinder 8 mounted on each of wheels FL to RR of the vehicle to generate a brake hydraulic pressure (a wheel cylinder pressure Pw). The brake apparatus 1 displaces a frictional member by the wheel cylinder pressure Pw to press the friction member against a rotational member on a wheel side, thereby generating a frictional force. By this frictional force, the brake apparatus 1 applies a hydraulic braking force to each of the wheels FL to RR.

The wheel cylinder 8 may be a wheel cylinder in a drum brake mechanism or a cylinder of a hydraulic brake caliper in a disk brake mechanism. The brake apparatus 1 includes two brake pipe systems, i.e., a primary system and a secondary system, and employs, for example, an X-split pipe configuration. The brake apparatus 1 may employ another pipe configuration, such as a front/rear split pipe configuration. Hereinafter, when a member provided in correspondence with the primary system and a member provided in correspondence with the secondary system should be distinguished from each other, indices P and S will be added at the ends of the respective reference numerals.

A brake pedal 2 is a brake operation member that receives an input of a brake operation from an operator (a driver). The brake pedal 2 is a so-called suspended-type brake pedal, and a proximal end thereof is rotatably supported by a shaft 201. A pad 202, which serves as a target that the driver presses, is provided at a distal end of the brake pedal 2. One end of a push rod 2a is connected rotatably by a shaft 203 at a proximal side of the brake pedal 2 between the shaft 201 and the pad 202.

A master cylinder 3 generates a brake hydraulic pressure (a master cylinder pressure Pm) by being activated by an operation performed on the brake pedal 2 by the driver (the brake operation). The brake apparatus 1 does not include a negative-pressure booster that boosts or amplifies a brake operation force (a force F pressing the brake pedal 2) by utilizing an intake negative pressure generated by the engine of the vehicle. This omission allows the brake apparatus 1 to be reduced in size.

The master cylinder 3 is connected to the brake pedal 2 via the push rod 2a, and is also replenished with the brake fluid from a reservoir tank (a reservoir) 4. The reservoir tank 4 is a brake fluid source that stores the brake fluid therein, and is a low-pressure portion opened to an atmospheric pressure. A bottom side (a vertically lower side) inside the reservoir tank 4 is partitioned (divided) into a primary hydraulic chamber space 41P, a secondary hydraulic chamber space 41S, and a pump intake space 42 by a plurality of partition members each having a predetermined height. The master cylinder 3 is a tandem-type master cylinder, and includes a primary piston 32P and a secondary piston 32S in series as master cylinder pistons axially displaceable according to the brake operation. The primary piston 32P is connected to the push rod 2a. The secondary piston 32S is configured as a free piston.

A stroke sensor 90 is provided at the brake pedal 2. The stroke sensor 90 detects an amount of a displacement of the brake pedal 2 (a pedal stroke S). The brake apparatus 1 may be configured to detect the pedal stroke S by including the stroke sensor 90 on the push rod 2a or the primary piston 32P. The pedal stroke S corresponds to a value acquired by multiplying an amount of an axial displacement of the push rod 2a or the primary piston 32P (a stroke amount) by a pedal ratio K of the brake pedal. The pedal ratio K is a ratio of the pedal stroke S to the stroke amount of the primary piston 32P, and is set to a predetermined value. The pedal ratio K can be calculated based on, for example, a ratio of a distance from the shaft 201 to the pad 202 to a distance from the shaft 201 to the shaft 203.

The stroke simulator 5 is activated in response to the brake operation performed by the driver. The stroke simulator 5 generates the pedal stroke S by an inflow of the brake fluid transmitted out from inside the master cylinder 3 according to the brake operation performed by the driver into the stroke simulator 5. A piston 52 of the stroke simulator 5 is activated axially in a cylinder 50 by the brake fluid supplied from the master cylinder 3. By this operation, the stroke simulator 5 generates an operation reaction force according to the brake operation performed by the driver.

A hydraulic control unit 6 is a braking control unit capable of generating the brake hydraulic pressure independently of the brake operation performed by the driver. An electronic control unit (hereinafter referred to as an ECU) 100 is a control unit that controls activation of the hydraulic control unit 6. The hydraulic control unit 6 receives supply of the brake fluid from the reservoir tank 4 or the master cylinder 3. The hydraulic control unit 6 is provided between the wheel cylinders 8 and the master cylinder 3, and can supply the master cylinder pressure Pm or a control hydraulic pressure to each of the wheel cylinders 8 individually.

The hydraulic control unit 6 includes a motor 7a of a pump 7 and a plurality of control valves (communication valves 26 and the like), as hydraulic devices (actuators) for generating the control hydraulic pressure. The pump 7 introduces the brake fluid therein from a brake fluid source other than the master cylinder 3 (the reservoir tank 4 or the like), and discharges the brake fluid toward the wheel cylinders 8. The pump 7 may be embodied with use of, for example, a plunger pump or a gear pump. The pump 7 is used in common by both the systems, and is rotationally driven by the electric motor (a rotational electric machine) 7a as a common driving source. The motor 7a can be embodied with use of, for example, a brushed motor. The communication valves 26 and the like are each opened and closed according to a control signal to switch a communication state of first oil passages 11 or the like. By this operation, the hydraulic control unit 6 controls a flow of the brake fluid. The hydraulic control unit 6 is provided so as to be able to increase the pressures in the wheel cylinders 8 with use of the hydraulic pressure generated by the pump 7 with the master cylinder 3 and the wheel cylinders 8 out of communication with each other. Further, the hydraulic control unit 6 includes hydraulic sensors 91 to 93, which detect hydraulic pressures at various locations such as a pressure discharged from the pump 7 and Pm.

Information input to the ECU 100 includes detected values transmitted from the stroke sensor 90 and the hydraulic sensors 91 to 93, and information regarding a running state transmitted from the vehicle side. The ECU 100 engages in information processing based on these various kinds of information according to a program installed therein. Further, the ECU 100 outputs an instruction signal to each of the actuators in the hydraulic control unit 6 according to a result of this processing, thereby controlling them. More specifically, the ECU 100 controls opening/closing operations of the communication valves 26 and the like, and the number of rotations of the motor 7a (i.e., an amount discharged from the pump 7). By this control, the ECU 100 controls the wheel cylinder pressure Pw at each of the wheels FL to RR, thereby realizes various kinds of brake control. For example, the ECU 100 realizes boosting control, anti-lock control, brake control for vehicle motion control, automatic brake control, regenerative cooperative brake control, and the like.

The boosting control assists the brake operation by generating a hydraulic braking force by which the brake operation force input by the driver is insufficient. The anti-lock control prevents or reduces a slip (a lock tendency) of any of the wheels FL to RR that is caused from the braking. The vehicle motion control is electronic stability control (hereinafter referred to as ESC) for preventing a sideslip and the like. The automatic brake control is adaptive cruise control or the like. The regenerative cooperative brake control controls the wheel cylinder pressure Pw so as to achieve a target deceleration (a target braking force) by collaborating with the regenerative brake.

(Configuration of Master Cylinder)

A primary hydraulic chamber 31P is defined between the two pistons 32P and 32S of the master cylinder 3. A coil spring 33P is set in the primary hydraulic chamber 31P in a pressed and compressed state. A secondary hydraulic chamber 31S is defined between the secondary piston 32S and an end of the cylinder 30 on a positive side in an x-axis direction. A coil spring 33S is set in the secondary hydraulic chamber 31S in a pressed and compressed state. A first oil passage 11 is opened to each of the hydraulic chambers 31P and 31S. Each of the hydraulic chambers 31P and 31S is provided so as to be connectable to the hydraulic control unit 6 and communicable with the wheel cylinders 8 via the first oil passage 11.

The driver's operation of pressing the brake pedal 2 causes the strokes of the pistons 32, thereby generating the master cylinder pressures Pm according to reductions in the volumes of the hydraulic chambers 31. Approximately equal master cylinder pressures Pm are generated in the two hydraulic chambers 31P and 31S. As a result, the brake fluid is supplied from the hydraulic chambers 31 toward the wheel cylinders 8 via the first oil passages 11. The master cylinder 3 can increase the pressures in the wheel cylinders 8a and 8d of the primary system via the oil passage (the first oil passage 11P) of the primary system with use of the master cylinder pressure Pm generated in the primary hydraulic chamber 31P. Further, the master cylinder 3 can increase the pressures in the wheel cylinders 8b and 8c of the secondary system via the oil passage (the first oil passage 11S) of the secondary system with use of the master cylinder pressure Pm generated in the secondary hydraulic chamber 31S.

(Configuration of Stoke Simulator)

Next, a configuration of the stroke simulator 5 will be described with reference to FIG. 1. The stroke simulator 5 includes the cylinder 50, the piston 52, and a spring 53. FIG. 1 illustrates a cross-section taken along a central axis of the cylinder 50 of the stroke simulator 5. The cylinder 50 is cylindrical, and has a cylindrical inner peripheral surface. The cylinder 50 includes a piston containing portion 501 relatively small in diameter on a negative side in the x-axis direction, and a spring containing portion 502 relatively large in diameter on the positive side in the x-axis direction. A third oil passage 13 (13A), which will be described below, is constantly opened on an inner peripheral surface of the spring containing portion 502.

The piston 52 is installed on an inner peripheral side of the piston containing portion 501 displaceably in the x-axis direction along an inner peripheral surface thereof. The piston 52 is a separation member (a partition wall) separating the inside of the cylinder 50 into at least two chambers (a positive pressure chamber 511 and a backpressure chamber 512). The positive pressure chamber 511 and the backpressure chamber 512 are defined on a negative side and a positive side of the piston 52 in the x-axis direction, respectively, inside the cylinder 50. The positive pressure chamber 511 is a space surrounded by a surface of the piston 52 on the negative side in the x-axis direction and the inner peripheral surface of the cylinder 50 (the piston containing portion 501). A second oil passage 12 is constantly opened to the positive pressure chamber 511. The backpressure chamber 512 is a space surrounded by a surface of the piston 52 on the positive side in the x-axis direction and the inner peripheral surface of the cylinder 50 (the spring containing portion 502 and the piston containing portion 501). The third oil passage 13A is constantly opened to the backpressure chamber 512.

A piston seal 54 is placed on an outer periphery of the piston 52 so as to extend in a direction around a central axis of the piston 52 (a circumferential direction). The piston seal 54 is in sliding contact with the inner peripheral surface of the cylinder 50 (the piston containing portion 501), and seals between the inner peripheral surface of the piston containing portion 501 and the outer peripheral surface of the piston 52. The piston seal 54 is a separation seal member that seals between the positive pressure chamber 511 and the backpressure chamber 512 to thereby liquid-tightly separate them, and complements the function of the piston 52 as the above-described separation member. The spring 53 is a coil spring (an elastic member) placed in the backpressure chamber 512 in a pressed and compressed state, and constantly biases the piston 52 toward the negative side in the x-axis direction. The spring 53 is provided deformably in the x-axis direction, and can generate the reaction force according to the displacement amount (the stroke amount) of the piston 52.

The spring 53 includes a first spring 531 and a second spring 532. The first spring 531 is shorter in diameter and dimension than the second spring 532, and has a short wire diameter. A spring constant of the first spring 531 is smaller than the second spring 532. The first and second springs 531 and 532 are disposed in series between the piston 52 and the cylinder 50 (the spring containing portion 502) via a retainer member 530.

(Configuration of Hydraulic Circuit)

Next, a hydraulic circuit of the hydraulic control unit 6 will be described with reference to FIG. 1. Members corresponding to the individual wheels FL to RR will be distinguished from one another if necessary, by indices a to d added at the ends of reference numerals thereof, respectively.

The first oil passages 11 connect the hydraulic chambers 31 of the master cylinder 3 and the wheel cylinders 8 to each other. A shut-off valve (a master cutoff valve) 21 is a normally-opened (opened when no power is supplied) electromagnetic valve provided in each of the first oil passages 11. Each of the first oil passages 11 is divided into a first oil passage 11A on a master cylinder 3 side and a first oil passage 11B on a wheel cylinder 8 side by the shut-off valve 21.

A solenoid IN valve (a pressure increase valve) SOL/V IN 25 is a normally-opened electromagnetic valve provided in correspondence with each of the wheels FL to RR (in each of first oil passages 11a to 11d) on the wheel cylinder 8 side with respect to the shut-off valve 21 (the first oil passage 11B) in each of the first oil passages 11. A bypass oil passage 110 is provided in parallel with each of the first oil passages 11 while bypassing the SOL/V IN 25. A check valve (a one-way valve or a non-return valve) 250 is provided in the bypass oil passage 110. The check valve 250 permits only a flow of the brake fluid from the wheel cylinder 8 side to the master cylinder 3 side.

An intake oil passage 15 is an oil passage connecting the reservoir tank 4 (the pump intake space 42) and an intake portion 70 of the pump 7. A discharge oil passage 16 connects a discharge portion 71 of the pump 7 and a portion in each of the first oil passages 11B between the shut-off valve 21 and the SOL/V IN 25. A check valve 160 is provided in the discharge oil passage 16, and permits only a flow from one side where the discharge portion 71 of the pump 7 is located (an upstream side) to another side where the first oil passage 11 is located (a downstream side). The check valve 160 is a discharge valve provided to the pump 7. The discharge oil passage 16 branches into a discharge oil passage 16P of the primary system and a discharge oil passage 16S of the secondary system, on the downstream side of the check valve 160. The individual discharge oil passages 16P and 16S are connected to the first oil passage 11P of the primary system and the first oil passage 11S of the secondary system, respectively. The discharge oil passages 16P and 16S function as a communication passage connecting the first oil passages 11P and 11S to each other. A communication valve 26P is a normally-closed (closed when no power is supplied) electromagnetic valve provided in the discharge oil passage 16P. A communication valve 26S is a normally-closed electromagnetic valve provided in the discharge oil passage 16S.

The pump 7 is a second hydraulic source capable of generating the wheel cylinder pressures Pw by generating the hydraulic pressures in the first oil passages 11 with use of the brake fluid supplied from the reservoir tank 4. The pump 7 is connected to the wheel cylinders 8a to 8d via the discharge oil passages 16P and 16S and the first oil passages 11P and 11S, and can increase the pressures in the wheel cylinders 8 by discharging the brake fluid to the discharge oil passages 16P and 16S.

A first pressure reduction oil passage 17 (a return flow oil passage) connects a portion in the discharge oil passage 16 between the check valve 160 and the communication valves 26, and the intake oil passage 15 to each other. A pressure adjustment valve 27 is a normally-opened electromagnetic valve as a first pressure reduction valve provided in the first pressure reduction oil passage (return flow oil passage) 17. The pressure adjustment valve 27 may be a normally-closed valve.

Second pressure reduction oil passages 18 connect the wheel cylinder 8 side of the first oil passages 11B with respect to the SOL/INs 25, and the intake oil passage 15 to each other. A solenoid OUT valve (a pressure reduction valve) SOL/V OUT 28 is a normally-closed electromagnetic valve as a second pressure reduction valve provided in each of the second pressure reduction oil passages 18. In the present embodiment, the first pressure reduction oil passage (return flow oil passage) 17 on one side closer to the intake oil passage 15 with respect to the pressure adjustment valve 27, and the second pressure reduction oil passages 18 on one side closer to the intake oil passage 15 with respect to the SOL/V OUTs 28 share a part thereof with each other.

The second oil passage 12 is a branch oil passage that branches off from the first oil passage 11B to be connected to the stroke simulator 5. The second oil passage 12 functions, together with the first oil passage 11B, as a positive-pressure side oil passage connecting the secondary hydraulic chamber 31S of the master cylinder 3 and the positive pressure chamber 511 of the stroke simulator 5 to each other. The second oil passage 12 may directly connect the secondary hydraulic chamber 31S and the positive pressure chamber 511 to each other without the intervention of the first oil passage 11B.

The third oil passage 13 is a first backpressure-side oil passage connecting the backpressure chamber 512 of the stroke simulator 5 and the first oil passage 11. More specifically, the third oil passage 13 branches off from a portion in the first oil passage 11S (11B) between the shut-off valve 21S and the SOL/V INs 25, and is connected to the backpressure chamber 512.

A stroke simulator IN valve SS/V IN 23 is a normally-closed electromagnetic valve provided in the third oil passage 13. The third oil passage 13 is divided into a third oil passage 13A on the backpressure chamber 512 side and a third oil passage 13B on the first oil passage 11 side by the SS/V IN 23. A bypass oil passage 130 is provided in parallel with the third oil passage 13 while bypassing the SS/V IN 23. The bypass oil passage 130 connects the third oil passage 13A and the third oil passage 13B to each other. A check valve 230 is provided in the bypass oil passage 130. The check valve 230 permits a flow of the brake fluid heading from the backpressure chamber 512 side (the third oil passage 13A) toward the first oil passage 11 side (the third oil passage 13B), and prohibits or reduces a flow of the brake fluid in an opposite direction therefrom.

A fourth oil passage 14 is a second backpressure-side oil passage connecting the backpressure chamber 512 of the stroke simulator 5 and the reservoir tank 4 to each other. The fourth oil passage 14 connects a portion in the third oil passage 13 between the backpressure chamber 512 and the SS/V IN 23 (the third oil passage 13A), and the intake oil passage 15 (or the first pressure reduction oil passage 17 on the intake oil passage 15 side with respect to the pressure adjustment valve 27 and the second pressure reduction oil passages 18 on the intake oil passage 15 side with respect to the SOL/V OUTs 28). The fourth oil passage 14 may be directly connected to the backpressure chamber 512 or the reservoir tank 4.

A stroke simulator OUT valve (a simulator cutoff valve) SS/V OUT 24 is a normally-closed electromagnetic valve provided in the fourth oil passage 14. A bypass oil passage 140 is provided in parallel with the fourth oil passage 14 while bypassing the SS/V OUT 24. A check valve 240 is provided in the bypass oil passage 140. The check valve 240 permits a flow of the brake fluid heading from the reservoir tank 4 (the intake oil passage 15) side toward the third oil passage 13A side, i.e., the backpressure chamber 512 side, and prohibits or reduces a flow of the brake fluid in an opposite direction therefrom.

The shut-off valves 21, the SOL/V INs 25, and the pressure adjustment valve 27 are each a proportional control valve, an opening degree of which is adjusted according to a current supplied to a solenoid. The SS/V IN 23, the SS/V OUT 24, the communication valves 26, and the SOL/V OUTs 28 are each a two-position (ON/OFF) valve, opening/closing of which is controlled to be switched between two values, i.e., switched to be either opened or closed. They can also be embodied with use of the proportional control valve instead of the two-position valve.

The master cylinder pressure sensor 91 is provided at a portion of the first oil passage 11S between the shut-off valve 21S and the master cylinder 3 (the first oil passage 11A). The master cylinder pressure sensor 91 detects a hydraulic pressure at this portion (the master cylinder pressure Pm and the hydraulic pressure in the positive pressure chamber 511 of the stroke simulator 5). The wheel cylinder pressure sensor (a primary system pressure sensor or a secondary system pressure sensor) 92 is provided in a portion of each of the first oil passages 11 between the shut-off valve 21 and the SOL/V INs 25. The wheel cylinder pressure sensor 92 detects a hydraulic pressure at this portion (the wheel cylinder pressure Pw).

The discharge pressure sensor 93 is provided in a portion of the discharge oil passage 16 between the discharge portion 71 of the pump 7 (the check valve 160) and the communication valves 26. The discharge pressure sensor 93 detects a hydraulic pressure at this portion (a pump discharge pressure). A first system is formed by a brake system (the first oil passages 11) that connects the hydraulic chambers 31 of the master cylinder 3 and the wheel cylinders 8 to each other with the shut-off valves 21 controlled in valve-opening directions. This first system can realize pressing force brake (non-boosting control) by generating the wheel cylinder pressures Pw from the master cylinder pressures Pm generated with use of the pressing force F.

On the other hand, a second system is formed by a brake system (the intake oil passage 15, the discharge oil passage 16, and the like) that includes the pump 7 and connects the reservoir tank 4 and the wheel cylinders 8 to each other with the shut-off valves 21 controlled in valve-closing directions. This second system constructs a so-called brake-by-wire device, which generates Pw from the hydraulic pressure generated with use of the pump 7, and can realize the boosting control and the like as brake-by-wire control. At the time of the brake-by-wire control (hereinafter simply referred to as by-wire control), the stroke simulator 5 creates the operation reaction force according to the brake operation performed by the driver.

(Configuration of ECU)

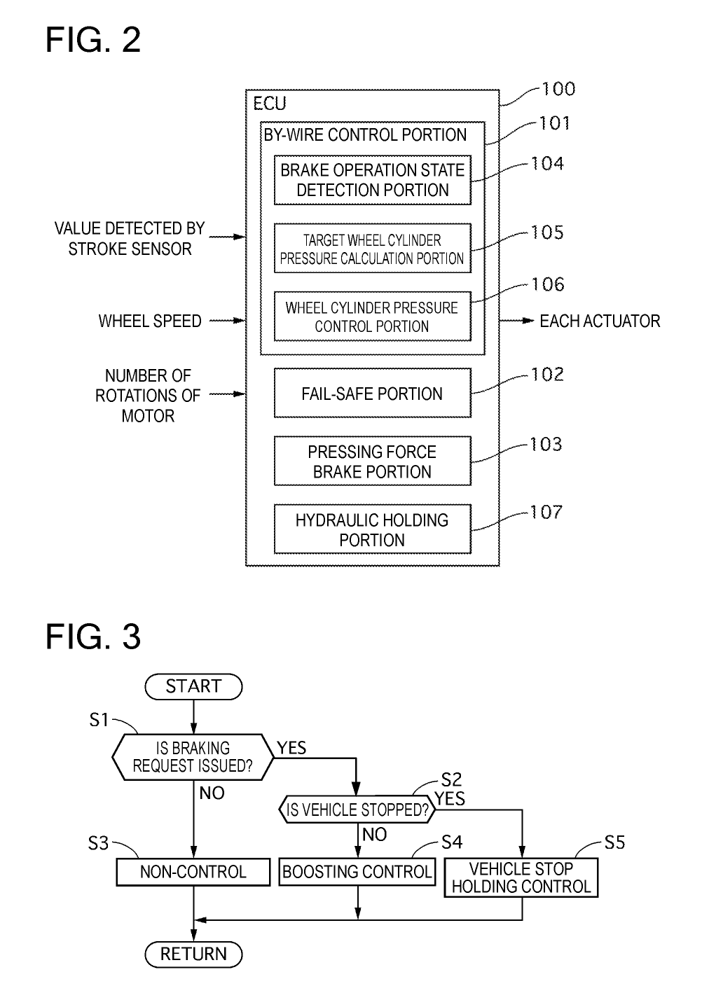

FIG. 2 is a control block diagram of the ECU 100. The ECU 100 includes a by-wire control portion 101, a pressing force brake portion 102, a fail-safe portion 103, and a hydraulic holding portion 107.

The by-wire control portion 101 closes the shut-off valves 21 to increase the pressures in the wheel cylinders 8 by the pump 7 according to a state of the brake operation performed by the driver. A specific will be made. The by-wire control portion 101 includes a brake operation state detection portion 104, a target wheel cylinder pressure calculation portion 105, and a wheel cylinder pressure control portion 106.

The brake operation state detection portion 104 detects the pedal stroke S as a brake operation amount input by the driver upon receiving the input of the value detected by the stroke sensor 90. Further, the brake operation state detection portion 104 detects whether the driver is performing the brake operation (whether the brake pedal 2 is being operated) based on the pedal stroke S. A pressing force sensor for detecting the pressing force F may be provided and the brake operation state detection portion 104 may be configured to detect or estimate the brake operation amount based on a value detected thereby. Alternatively, the brake operation state detection portion 104 may be configured to detect or estimate the brake operation amount based on the value detected by the master cylinder pressure sensor 91. In other words, the brake operation state detection portion 104 may use, instead of the pedal stroke S, another appropriate variable as the brake operation amount to be used in the control.

The target wheel cylinder pressure calculation portion 105 calculates a target wheel cylinder pressure Pw*. For example, at the time of the boosting control, the target wheel cylinder pressure calculation portion 105 calculates, based on the detected pedal stroke S (the brake operation amount), the target wheel cylinder pressure Pw* that realizes an ideal relationship between the pedal stroke S and a brake hydraulic pressure requested by the driver (a vehicle deceleration requested by the driver) according to a predetermined boosting ratio. For example, a predetermined relationship between the pedal stroke S and the wheel cylinder pressure Pw (the braking force) that would be realized when the negative-pressure booster is activated in a brake apparatus including the negative-pressure booster normal in size is set as the above-described ideal relationship for calculating the target wheel cylinder pressure Pw*. The wheel cylinder pressure control portion 106 controls the shut-off valves 21 in the valve-closing directions, thereby bringing the hydraulic control unit 6 into a state capable of creating the wheel cylinder pressures Pw with use of the pump 7 (the second system) (pressure increase control). The wheel cylinder pressure control portion 106 controls each of the actuators in the hydraulic control unit 6 in this state, thereby performing hydraulic control (for example, the boosting control) for realizing the target wheel cylinder pressure Pw*. More specifically, the wheel cylinder pressure control portion 106 controls the shut-off valves 21 in the valve-closing directions, the communication valves 26 in valve-opening directions, and the pressure adjustment valve 27 in a valve-closing direction, and also activates the pump 7. Controlling each of the actuators in this manner allows desired brake fluid to be transmitted from the reservoir tank 4 side to the wheel cylinders 8 via the intake oil passage 15, the pump 7, the discharge oil passage 16, and the first oil passages 11.

The brake fluid discharged from the pump 7 flows into the first oil passages 11B via the discharge oil passage 16. This brake fluid flows into each of the wheel cylinders 8, thereby increasing the pressure in each of the wheel cylinders 8. In other words, the pressure in each of the wheel cylinders 8 is increased with use of the hydraulic pressure generated in the first oil passage 11B with use of the pump 7. At this time, a desired braking force can be acquired by performing feedback control on the number of rotations of the pump 7 and a valve-opening state (an opening degree and/or the like) of the pressure adjustment valve 27 so that the value detected by the wheel cylinder pressure sensor 92 approaches the target wheel cylinder pressure Pw*. In other words, the wheel cylinder pressures Pw can be adjusted by controlling the valve-opening state of the pressure adjustment valve 27 and allowing the brake fluid to leak from the discharge oil passage 16 or the first oil passages 11 to the intake oil passage 15 via the pressure adjustment valve 27 as appropriate. In the present embodiment, the wheel cylinder pressures Pw is controlled basically by changing the valve-opening state of the pressure adjustment valve 27 instead of the number of rotations of the pump 7 (the motor 7a). Controlling the shut-off valves 21 in the valve-closing directions and blocking the communication between the master cylinder 3 side and the wheel cylinder 8 side facilitates the control of the wheel cylinder pressures Pw independently of the brake operation performed by the driver.

On the other hand, the wheel cylinder pressure control portion 106 controls the SS/V OUT 24 in a valve-opening direction. As a result, communication is established between the backpressure chamber 512 of the stroke simulator 5 and the intake oil passage 15 (the reservoir tank 4) side. Therefore, when the brake fluid is discharged from the master cylinder 3 according to the operation of pressing the brake pedal 2, and this brake fluid flows into the positive pressure chamber 511 of the stroke simulator 5, the piston 52 is activated. As a result, the pedal stroke S is generated. The brake fluid flows out from the backpressure chamber 512 by a fluid amount as much as the fluid amount flowing into the positive pressure chamber 511. This brake fluid is discharged toward the intake oil passage 15 (the reservoir tank 4) side via the third oil passage 13A and the fourth oil passage 14. The fourth oil passage 14 only has to be connected to a low pressure portion into which the brake fluid can flow, and does not necessarily have to be connected to the reservoir tank 4. Further, the operation reaction force applied to the brake pedal 2 (the pedal reaction force) is generated due to the force with which the spring 53 of the stroke simulator 5, the hydraulic pressure in the backpressure chamber 512, and the like press the piston 52. In other words, the stroke simulator 5 generates a characteristic of the brake pedal 2 (an F-S characteristic, which is a relationship of the pedal stroke S to the pressing force F) at the time of the by-wire control.

The pressing force brake portion 102 opens the shut-off valves 21, thereby increasing the pressures in the wheel cylinders 8 with use of the master cylinder 3. The pressing force brake portion 102 controls the shut-off valves 21 in the valve-opening directions, thereby bringing the hydraulic control unit 6 into a state capable of generating the wheel cylinder pressures Pw from the master cylinder pressures Pm (the first system), thus realizing the pressing force brake. At this time, the pressing force brake portion 102 controls the SS/V OUT 24 in a valve-closing direction, thereby making the stroke simulator 5 inactive in response to the brake operation performed by the driver. As a result, the brake fluid is efficiently supplied from the master cylinder 3 toward the wheel cylinders 8. Therefore, reductions in the wheel cylinder pressures Pw generated by the pressing force F input by the driver can be prevented or cut down. More specifically, the pressing force brake portion 102 deactivates all of the actuators in the hydraulic control unit 6. The pressing force brake portion 102 may be configured to control the SS/V IN 23 in a valve-opening direction.

The fail-safe portion 103 detects occurrence of an abnormality (a failure or a malfunction) in the brake apparatus 1 (the brake system). For example, the fail-safe portion 103 detects a failure in the actuator (the pump 7, the motor 7a, the pressure adjustment valve 27, or the like) in the hydraulic control unit 6 based on a signal from the brake operation state detection portion 104 and the signal from each of the sensors. Alternatively, the fail-safe portion 103 detects an abnormality in an in-vehicle power source (a battery) supplying power to the brake apparatus 1, or the ECU 100.

Upon detecting the occurrence of the abnormality during the by-wire control, the fail-safe portion 103 activates the pressing force brake portion 102, thereby switching the brake control from the by-wire control to the pressing force brake. More specifically, the fail-safe portion 103 deactivates all of the actuators in the hydraulic control unit 6, thereby causing the brake apparatus 1 to transition to the pressing force brake. The shut-off valves 21 are the constantly-opened valves. This allows the shut-off valves 21 to be opened, thereby succeeding in automatically realizing the pressing force brake, when a power failure has occurred. The SS/V OUT 24 is the normally-closed valve, which allows the SS/V OUT 24 to be closed, thereby automatically deactivating the stroke simulator 5, when the power failure has occurred. Further, the communication valves 26 are the normally-closed valves, which allows the brake hydraulic systems of the two systems to operate independently of each other, thereby allowing the systems to increase the pressures in the wheel cylinders based on the pressing force F separately from each other, when the power failure has occurred. Due to this configuration, a fail-safe performance can be improved.

The control performed by the hydraulic holding portion 107 will be separately described in detail.

[Hydraulic Holding Control]

In the following description, the hydraulic holding portion 107 will be described referring to an example in which the hydraulic pressures are held when the vehicle is stopped. FIG. 3 is a flowchart illustrating processing for determining a control mode, which is performed by the ECU 100. The present processing illustrated in the flowchart that will be described below is built in as software to be executed by the ECU 100 at predetermined time intervals.

In step S1, the ECU 100 determines whether a braking request is issued. The braking request is determined to be issued when the pedal stroke S reaches or exceeds a predetermined stroke. The ECU 100 may be configured to determine the braking request based on the pressing force F. If the ECU 100 determines that the braking request is not issued, the processing proceeds to step S3. If the ECU 100 determines that the braking request is issued, the processing proceeds to step S2.

In step S2, the ECU 100 determines whether the vehicle is stopped. The vehicle can be determined to be stopped, for example, in the following manner. A wheel speed sensor is provided to each of the wheels, and the ECU 100 determines that all outputs of the wheel speed sensors reduce to zero, and determines that the vehicle is stopped according to continuation of this state for a predetermined time period. If the ECU 100 determines that the vehicle is not stopped in step S2, the processing proceeds to step S4. If the ECU 100 determines that the vehicle is stopped in step S2, the processing proceeds to step S5. In step S3, a non-control mode is set. In the non-control mode, all of the actuators in the hydraulic control unit 6 are brought into deactivated states.

In step S4, a boosting control mode is set. More specifically, the hydraulic control is performed by the by-wire control portion 101.

In step S5, a vehicle stop holding control mode is set. More specifically, the control for holding the hydraulic pressures in the wheel cylinders 8 is performed by the hydraulic holding portion 107.

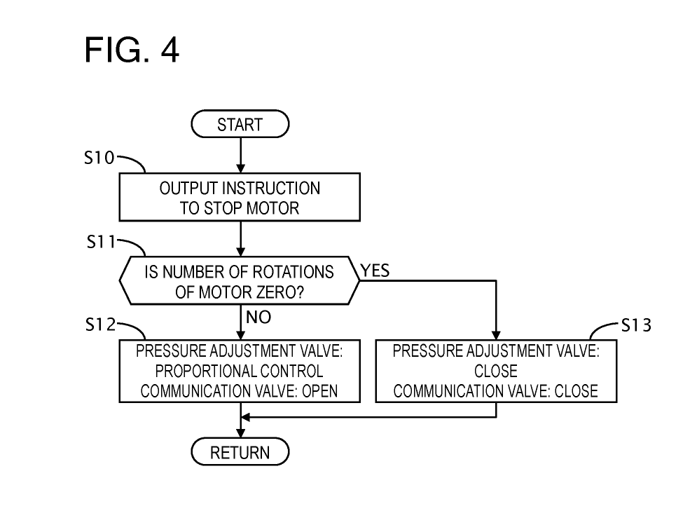

FIG. 4 is a flowchart illustrating a flow of control processing performed by the hydraulic holding portion 107 in the vehicle stop holding control mode.

In step S10, the hydraulic holding portion 107 outputs an instruction to stop the motor 7a.

In step S11, the hydraulic holding portion 107 determines whether the motor 7a is stopped (the number of rotations reduces to zero). The detection of the number of rotations of the motor can be achieved by detecting the number of rotations of the motor with use of an encoder, or detecting a voltage between motor terminals and a motor current and estimating the number of rotations of the motor from a calculation based on a physical relationship. If the hydraulic holding portion 107 determines that the motor 7a is rotating in step S11, the processing proceeds to step S12. If the hydraulic holding portion 107 determines that the motor 7a is stopped in step S11, the processing proceeds to step S13.

In step S12, the hydraulic holding portion 107 proportionally controls the pressure adjustment valve 27, and also opens the communication valves 26P and 26S. In step S12, the brake fluid is discharged from the pump 7 since the motor 7a is rotating. The hydraulic holding portion 107 proportionally controls the pressure adjustment valve 27 based on the values output from the wheel cylinder pressure sensors 92P and 92S to control the wheel cylinder pressures to the target values. Further, the pump 7 is in operation while the motor 7a is rotating, so that, if the communication valves 26P and 26S are closed before the vehicle is stopped, the brake fluid would flow from the pump 7 into the discharge oil passage 16, creating a highly rigid closed space in the discharge oil passage 16. Therefore, the communication valves 26P and 26S are opened.

In step S13, the hydraulic holding portion 107 closes all of the pressure adjustment valve 27 and the communication valves 26P and 26S.

[Timing Chart During Braking]

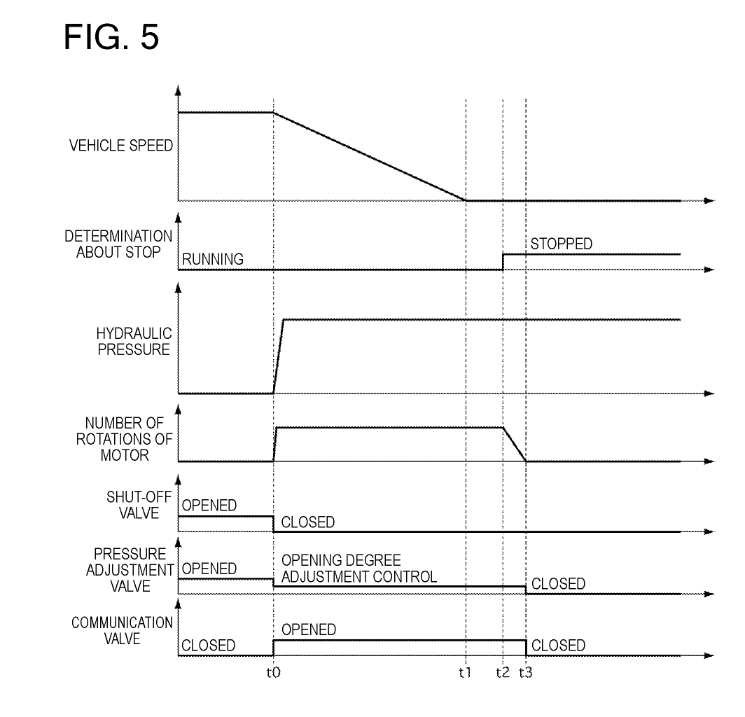

FIG. 5 is a timing chart illustrating how the operation proceeds since the vehicle is in a running state until the braking force is generated and the vehicle is stopped. The timing chart illustrated in FIG. 5 indicates the vehicle speed, the determination about whether the vehicle is stopped, the value detected by each of the wheel cylinder pressure sensors 92 and the discharge pressure sensor 93, the number of rotations of the motor 7a, whether the shut-off valves 21 are opened or closed, whether the pressure adjustment valve 27 is opened or closed, and whether the communication valves 26 are opened or closed.

Before time t0, the vehicle is running at a certain speed.

At time t0, the motor 7a is activated according to the braking request, and the number of rotations increases. According thereto, the pump 7 is also activated, and the hydraulic pressures increase. At the same time, the shut-off valves 21P and 21S are closed, the opening degree of the pressure adjustment valve 27 is adjusted, and the communication valves 26P and 26S are opened. As a result, the brake fluid supplied from the pump 7 is guided to the wheel cylinders 8, causing the generation of the wheel cylinder pressures, the acquisition of the braking forces, and thus a slowdown of the vehicle.

The vehicle is stopped at time t1, and the vehicle is determined to be stopped at time t2. When the vehicle is determined to be stopped, the driving of the motor 7a is stopped. Therefore, the number of rotations of the motor starts reducing.

At time t3, the number of rotations of the motor is determined to reduce to zero. When the number of rotations of the motor is determined to reduce to zero, the adjustment valve 27 and the communication valves 26P and 26S are closed. This allows the brake fluid to be confined in the first oil passages 11, the discharge oil passage 16, and each of the wheel cylinders 8 enclosed by the pressure adjustment valve 27 and the shut-off valves 21P and 21S, thereby allowing the wheel cylinder pressures to be held.

[Function of Hydraulic Holding Control]

One possible method to hold the hydraulic pressure in each of the wheel cylinders 8 is to close the shut-off valves 21 and the pressure adjustment valve 27. However, if an abnormality has occurred in a driving element of the pressure adjustment valve 27 to lead to such a malfunction that a current cannot flow to the solenoid of the pressure adjustment valve 27 in this state, no power is supplied to the pressure adjustment valve 27 and the pressure adjustment valve 27 is kept in the opened state. The pressure adjustment valve 27 kept opened causes the brake fluid to flow out from the discharge oil passage 16 via the first pressure reduction oil passage 17, thereby resulting in a failure to maintain the hydraulic pressures in the wheel cylinders 8. Besides that, a short circuit malfunction of the solenoid of the pressure adjustment valve 27 and a disconnection malfunction also bring about a similar influence. The pressure adjustment valve 27 may be the normally-closed electromagnetic valve as described above, but, even in this case, an opening malfunction may occur due to an electric malfunction such as the driving element stuck in an ON state. Further, if the check valve 160 loses its sealing performance, the hydraulic pressures in the wheel cylinders 8 may also be unable to be maintained, because the brake fluid flows out from the discharge oil passage 16 to the intake oil passage 15 via the pump 7.

Needless to say, the system should be configured to be able to detect these malfunctions by a fail-safe. However, the detection of the malfunction requires a predetermined time, so that the hydraulic pressures in the wheel cylinders 8 undesirably reduce in no small measure since the malfunction has occurred. If the road surface is inclined, the vehicle may be undesirably moved against the driver's intention due to the reductions in the hydraulic pressures in the wheel cylinders 8. At this time, the supply of the brake fluid from the master cylinder 3 is blocked by the shut-off valves 21P and 21S, and therefore the hydraulic pressures in the wheel cylinders 8 cannot be generated from the hydraulic pressures generated in the master cylinder 3 even if the pressing force F applied to the pedal 2 increases when the braking force reduces. Therefore, the driver may feel anxiety and discomfort until the malfunction is detected.

In a case where the shut-off valves 21P and 21S have a valve-opening malfunction, the braking force can be generated from the driver's pressing force F due to the establishment of the communication through the first oil passages 11 (due to the establishment of the communication between the master cylinder 3 and the wheel cylinders 8).

To solve such a problem, in the first embodiment, the brake apparatus 1 is configured to close the communication valves 26P and 26S in addition to the pressure adjustment valve 27. Due to this configuration, the hydraulic pressures in the first oil passage 11B (11P) and the wheel cylinders 8a and 8d of the primary system can be held due to the shut-off valve 21P and the communication valve 26P. Further, the hydraulic pressures in the first oil passage 11B (11S) and the wheel cylinders 8b and 8c of the secondary system can be held due to the shut-off valve 21S and the communication valve 26S.

In the first embodiment, the pressure adjustment valve 27 and the communication valves 26 are brought into the closed states, and the oil passages are doubly closed from the first oil passages 11B to the first pressure reduction oil passage 17 or from the first oil passages 11B to the intake oil passage 15, so that the reliability of holding the wheel cylinder pressures can be further improved. For example, even when the opening malfunction has occurred in the pressure adjustment valve 27 or the check valve 160 during the hydraulic holding control, the wheel cylinder pressures can be continuously held unless the communication valve 26P or the communication valve 26S also has the opening malfunction at the same time. Further, even when the opening malfunction has occurred in the communication valve 26P or the communication valve 26S during the hydraulic holding control, the wheel cylinder pressures can be continuously held unless the pressure adjustment valve 27 also has the opening malfunction at the same time.

Further, the pressure adjustment valve 27 and the communication valves 26P and 26S are closed at the same time at time t3 in the timing chart illustrated in FIG. 5, but the present embodiment is not necessarily limited to closing them at the same time and may be configured to close the pressure adjustment valve 27 after closing the communication valves 26P and 26S. Regarding the two communication valves, the present embodiment is not limited to closing the communication valves 26P and 26S at the same time, and may be configured to first close any one of the communication valves and close the remaining communication valve after that.

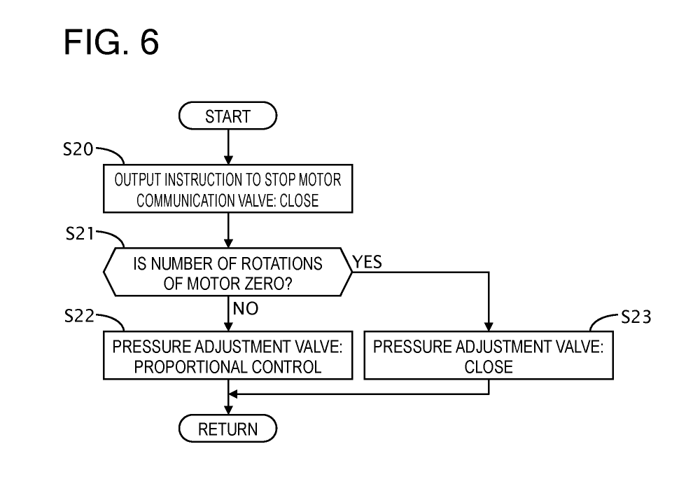

As other processing of the hydraulic holding control, the communication valves 26P and 26S can also be closed while the motor 7a is rotating. FIG. 6 is a flowchart illustrating a flow of the control processing performed by the hydraulic holding portion 107 in the operation in the vehicle stop holding control mode.

In step S20, the hydraulic holding portion 107 outputs an instruction to stop the motor 7a, and also closes the communication valves 26P and 26S.

In step S21, the hydraulic holding portion 107 determines whether the motor 7a is stopped (the number of rotations reduces to zero). If the hydraulic holding portion 107 determines that the motor 7a is rotating in step S21, the processing proceeds to step S22. If the hydraulic holding portion 107 determines that the motor 7a is stopped in step S21, the processing proceeds to step S23.

In step S22, the hydraulic holding portion 107 proportionally controls the pressure adjustment valve 27. In step S22, the brake fluid is discharged from the pump 7 since the motor 7a is rotating. The communication valves 26P and 26S are closed at this time, so that the discharge oil passage 16 is filled with an excessive hydraulic amount and the hydraulic pressure increases therein. However, an unnecessary hydraulic pressure can be released by proportionally controlling the pressure adjustment valve 27.

In step S23, the hydraulic holding portion 107 closes the pressure adjustment valve 27.

The excessive increase in the hydraulic pressure in the discharge oil passage 16 can also be prevented or cut down even if the communication valves 26P and 26S are closed when the motor 7a is rotating in the operation in the vehicle stop holding control mode, like the control processing illustrated in FIG. 6.

Further, the excessive increase in the hydraulic pressure in the discharge oil passage 16 can also be prevented or cut down by mechanically or electrically setting relief pressures of the communication valves 26P and 26S and the pressure adjustment valve 27 at the time of the valve closing, even if the communication valves 26P and 26S and the pressure adjustment valve 27 are closed at the same time when the motor 7a is rotating.

(Detection of Abnormality in System)

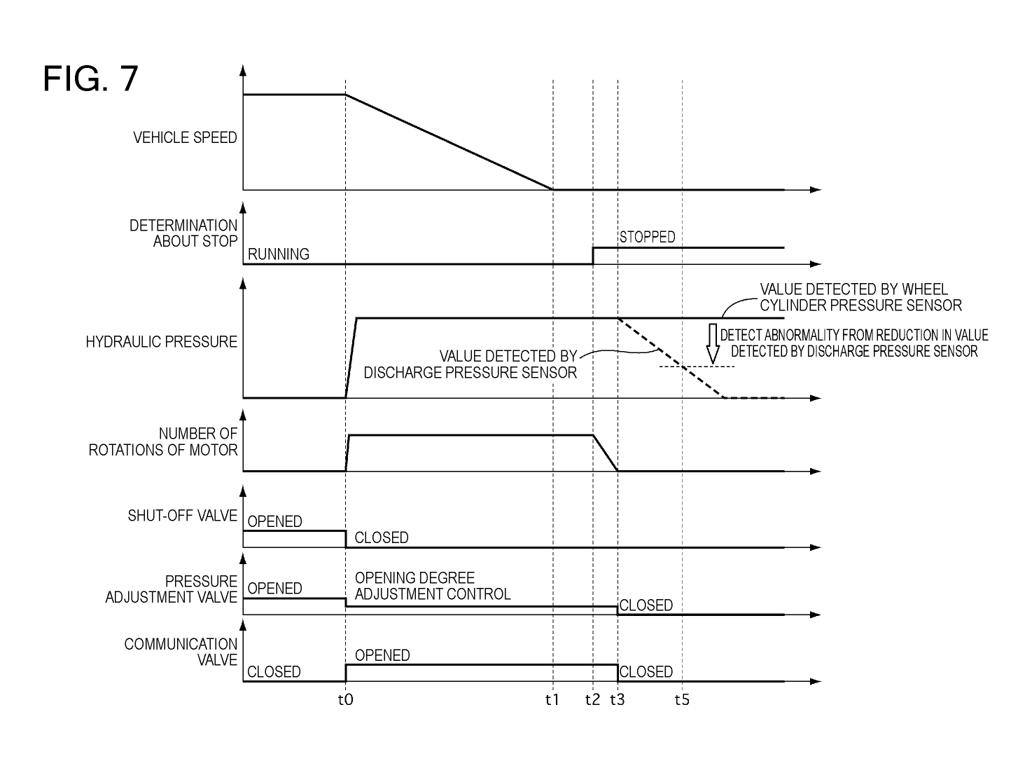

Next, a method for detecting an abnormality in the brake apparatus 1 (the brake system) will be described. FIG. 7 is a timing chart illustrating how the operation proceeds since the vehicle is in the running state until the braking force is generated and the vehicle is stopped. This is a timing chart. The timing chart illustrated in FIG. 7 is similar to the timing chart illustrated in FIG. 5 until time t3, and therefore a description thereof will be omitted here.

After time t3, the hydraulic pressure in each of the first oil passages 11B (11P and 11S) and the discharge oil passage 16 should be kept at the hydraulic pressure when the hydraulic pressure starts to be held if the brake apparatus 1 is normal. However, the hydraulic pressure may be unable to be held if an abnormality has occurred in a component around the discharge oil passage 16.

For example, if a leak has occurred in the check valve 160 and the oil flows out to the intake oil passage 15 via the pump 7, the hydraulic pressure in the discharge oil passage 16 reduces. In this case, the hydraulic pressures in the first oil passage 11B (11P) and the first oil passage 11B (11S) can be held due to the communication valves 26 and the shut-off valves 21, so that the values detected by the wheel cylinder pressure sensors 92P and 92S indicate the held hydraulic pressures, and only the value detected by the discharge pressure sensor 93 installed in the discharge oil passage 16 reduces. Therefore, when the value indicated by the discharge pressure sensor 93 reduces by a preset hydraulic pressure compared to when the hydraulic pressure starts to be held, the present configuration can detect an abnormality in the holding of the hydraulic pressure in the system relating to the discharge oil passage 16 (time t5).

Hypothetically supposing that the communication valves 26 are not provided, this omission would lead to reductions in the hydraulic pressures in all of the first oil passages 11B and the discharge oil passage 16, resulting in a difficulty in narrowing down a failed portion. Compared thereto, the present configuration can narrow down the failed portion to the components around the discharge oil passage 16 and therefore achieves excellent detectability. Similarly, a malfunction in the primary system can be detected if only the value detected by the wheel cylinder pressure sensor 92P reduces, and a malfunction in the secondary system can be detected if only the value detected by the wheel cylinder pressure sensor 92S reduces.

[Effect]

(1) The brake control apparatus includes the pump 7 (a hydraulic source) configured to supply the brake fluid to the wheel cylinder 8, the discharge oil passage 16 (a first oil passage) connecting the pump 7 and the wheel cylinder 8 to each other, the communication valve 26 (a first valve) provided in the discharge oil passage 16, the first pressure reduction oil passage 17 (a return flow oil passage) connected to the discharge oil passage 16 between the pump 7 and the communication valve 26 and configured to return the brake fluid supplied from the pump 7 to the low-pressure portion, the pressure adjustment valve 27 provided in the first pressure reduction oil passage 17 and configured to adjust the brake hydraulic pressure in the discharge oil passage 16, and the hydraulic holding portion 107 configured to hold the hydraulic pressure in the wheel cylinder 8 set by the brake hydraulic pressure supplied from the pump 7 to the wheel cylinder 8 by activating the pressure adjustment valve 27 and the communication valve 26 in the respective valve-closing directions.

Therefore, by closing the pressure adjustment valve 27 and the communication valve 26, the first embodiment can doubly block the oil passage from the first oil passage 11B to the first pressure reduction oil passage 17 or from the first oil passage 11B to the intake oil passage 15, thereby improving the reliability of holding the wheel cylinder pressure.

(2) The brake control apparatus further includes the vehicle stop state determination portion (step S2) configured to determine the stop of the vehicle. The hydraulic holding portion 107 holds the hydraulic pressure in the wheel cylinder 8 after the vehicle stop state determination portion determines (step S2) that the vehicle is stopped.

Therefore, the first embodiment can hold the hydraulic pressure in the wheel cylinder 8 after the vehicle is stopped, thereby keeping the vehicle at the stopped state.

(3) The pump 7 is the pump including the check valve 160 (a discharge valve) configured to permit only the flow in the discharge direction. The pump 7 is stopped after the vehicle stop state determination portion (step S2) determines that the vehicle is stopped.

Therefore, the first embodiment allows the pump 7 to be stopped when the vehicle is stopped, thereby achieving energy saving.

(4) The communication valve 26 and/or the pressure adjustment valve 27 is/are closed after the pump 7 is stopped.

Therefore, the first embodiment can prevent or cut down the excessive increase in the hydraulic pressure in the discharge oil passage 16.

(5) The communication valve 26 and the pressure adjustment valve 27 are the electromagnetic valves. At least one of the electromagnetic valves is the normally-closed valve.

Therefore, the first embodiment eliminates the necessity of supplying power to the normally-closed electromagnetic valve during the control for holding the hydraulic pressure in the wheel cylinder 8, thereby achieving the power saving.

(6) The brake control apparatus further includes the first oil passage 11 (a second oil passage) connecting the position in the discharge oil passage 16 that is located between the communication valve 26 and the wheel cylinder 8, and the master cylinder 3 to each other. The brake control apparatus further includes the shut-off valve 21 provided in the first oil passage 11. The hydraulic holding portion 107 holds the hydraulic pressure in the wheel cylinder 8 by activating the shut-off valve 21 in the valve-closing direction.

Therefore, the first embodiment allows the hydraulic pressure to be held in the wheel cylinder 8 even in the by-wire system.

(7) The brake control apparatus is mounted on the vehicle. The brake control apparatus includes the primary system (a first system) including the plurality of wheel cylinders 8a and 8d among the plurality of wheel cylinders 8 mounted on the vehicle, and the secondary system (a second system) including the remaining wheel cylinders 8b and 8c among the wheel cylinders 8. The systems each include the discharge oil passage 16 and the communication valve 26. The first pressure reduction oil passage 17 is connected to a portion between the communication valves 26 of the primary system and the secondary system.

Therefore, the first embodiment allows the first pressure reduction oil passage 17 to be shared by both the systems, thereby achieving simplification of the hydraulic circuit.

(8) The brake control apparatus includes the pump 7 (a hydraulic source) configured to supply the brake fluid to the wheel cylinder 8, the discharge oil passage 16 (a first oil passage) connecting the pump 7 and the wheel cylinder 8 to each other, the communication valve 26 (a first valve) provided in the discharge oil passage 16, the first pressure reduction oil passage 17 (a pressure adjustment oil passage) connected to the discharge oil passage 16 between the pump 7 and the communication valve 26 and connected to the low-pressure portion, the pressure adjustment valve 27 provided in the first pressure reduction oil passage 17 in series with the communication valve 26, and the hydraulic holding portion 107 configured to hold the hydraulic pressure in the wheel cylinder 8 set by the brake hydraulic pressure supplied from the pump 7 to the wheel cylinder 8 by activating the pressure adjustment valve 27 and the communication valve 26 in the respective valve-closing directions.

Therefore, by closing the pressure adjustment valve 27 and the communication valve 26, the first embodiment can doubly block the oil passage from the first oil passage 11B to the first pressure reduction oil passage 17 or from the first oil passage 11B to the intake oil passage 15, thereby improving the reliability of holding the wheel cylinder pressure.

(9) The pump 7 is stopped before the hydraulic holding portion 107 is activated.

Therefore, the first embodiment allows the pump 7 to be stopped during the control for holding the hydraulic pressure in the wheel cylinder 8, thereby achieving the energy saving.

(10) The brake control apparatus further includes the vehicle stop state determination portion (step S2) configured to determine the stop of the vehicle. The hydraulic holding portion 107 holds the hydraulic pressure in the wheel cylinder 8 after the vehicle stop state determination portion determines (step S2) that the vehicle is stopped.

Therefore, the first embodiment can hold the hydraulic pressure in the wheel cylinder 8 after the vehicle is stopped, thereby keeping the vehicle at the stopped state.

(11) The brake system includes the master cylinder 3 including the primary hydraulic chamber 31P configured to supply the hydraulic pressure to the wheel cylinder 8a, 8d belonging to the primary system provided to the vehicle and the secondary hydraulic chamber 31S configured to supply the hydraulic pressure to the wheel cylinder 8b, 8c belonging to the secondary system, the first oil passage 11P (a primary system oil passage) connecting the primary hydraulic chamber 31P and the wheel cylinder 8a, 8d belonging to the primary system to each other, the first oil passage 11S (a secondary system oil passage) connecting the secondary hydraulic chamber 31S and the wheel cylinder 8b, 8c belonging to the secondary system to each other, the discharge oil passage 16 (a connection oil passage) provided between the first oil passage 11P and the first oil passage 11S and connecting the first oil passage 11P and the first oil passage 11S to each other, the pump 7 (a hydraulic source) connected to the discharge oil passage 16 and configured to supply the brake fluid to the corresponding wheel cylinder 8 via each of the first oil passage 11P and the first oil passages 11S, the communication valve 26P (a first communication valve) provided between the discharge oil passage 16 and the first oil passage 11P, the communication valve 26S (a second communication valve) provided between the discharge oil passage 16 and the first oil passage 11S, the first pressure reduction oil passage 17 (a pressure reduction oil passage) connecting the discharge oil passage 16 and the low-pressure portion to each other, the pressure adjustment valve 27 provided in the first pressure reduction oil passage 17, and the hydraulic holding portion 107 configured to hold the brake hydraulic pressure supplied from the pump 7 to the corresponding wheel cylinder 8 by controlling each of the communication valves 26P and 26S and the pressure adjustment valve 27 in the respective valve-closing directions.

Therefore, by closing the pressure adjustment valve 27 and the communication valve 26, the first embodiment can doubly block the oil passage from the first oil passage 11B to the first pressure reduction oil passage 17 or from the first oil passage 11B to the intake oil passage 15, thereby improving the reliability of holding the wheel cylinder pressure.

(12) The pump 7 is the pump including the check valve 160 (a discharge valve) configured to permit only the flow in the discharge direction. The hydraulic pressure in each of the wheel cylinders 8 is increased by the brake fluid discharged from the pump 7. The pump 7 is stopped before the hydraulic holding portion 107 starts holding the hydraulic pressure after the vehicle stop state determination portion (step S2) determines that the vehicle is stopped.

Therefore, the first embodiment can hold the hydraulic pressure in the wheel cylinder 8 after the vehicle is stopped, thereby keeping the vehicle at the stopped state.

### Second Embodiment

In the first embodiment, the pressure adjustment valve 27 is closed during the control for holding the hydraulic pressures in the wheel cylinders 8. In a second embodiment, the brake apparatus 1 is configured to first close the pressure adjustment valve 27 at the time of the start of the control for holding the hydraulic pressures in the wheel cylinders 8, but open the pressure adjustment valve 27 after that. In the following description, the brake apparatus 1 according to the second embodiment will be described, but a similar configuration to the first embodiment will be indicated by the same reference numeral and a description thereof will be omitted.

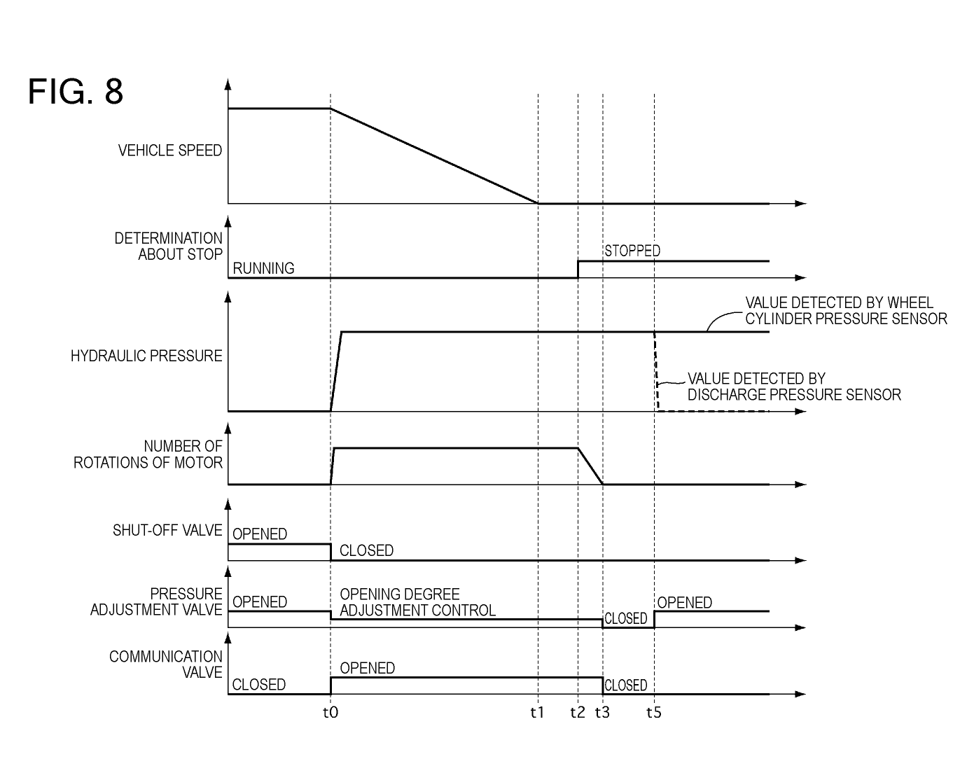

FIG. 8 is a timing chart illustrating how the operation proceeds since the vehicle is in the running state until the braking force is generated and the vehicle to be stopped. This timing chart is similar to the timing chart illustrated in FIG. 2 according to the first embodiment until time t3, and therefore a description thereof will be omitted here.

At time t3, the number of rotations of the motor is determined to reduce to zero. When the number of rotations of the motor is determined to reduce to zero, the adjustment valve 27 and the communication valves 26P and 26S are closed. This allows the brake fluid to be confined in the first oil passages 11, the discharge oil passage 16, and each of the wheel cylinders 8 enclosed by the pressure adjustment valve 27 and the shut-off valves 21P and 21S, thereby allowing the wheel cylinder pressures to be held.

At time t6, the pressure adjustment valve 27 is opened. The pressure adjustment valve 27 is opened when an amount of a change in the value detected by each of the wheel cylinder pressure sensors 92P and 92S and the discharge pressure sensor 93 since time t3 until a predetermined time period has elapsed is smaller than a threshold value. In other words, the pressure adjustment valve 27 is opened when the hydraulic pressures in the wheel cylinders 8 can be normally held.

When the pressure adjustment valve 27 is opened, the hydraulic pressure in the discharge oil passage 16 reduces (the value detected by the discharge pressure sensor 93 reduces). The hydraulic pressures in the first oil passage 11B (11P) and the wheel cylinders 8a and 8d of the primary system are held due to the shut-off valve 21P and the communication valve 26P of the primary system. The hydraulic pressures in the first oil passage 11B (11S) and the wheel cylinders 8b and 8c of the secondary system are held due to the shut-off valve 21S and the communication valve 26S of the secondary system.

[Function]

In the second embodiment, the normally-opened pressure adjustment valve 27 can be opened during the control for holding the hydraulic pressures in the wheel cylinders 8, which contributes to reducing power consumption. If the opening malfunction has occurred in the communication valve 26P or the communication valve 26S during the hydraulic holding control, the wheel cylinder pressures in the system having the malfunction therein reduce, but the wheel cylinder pressures in the normal system can be continuously held and therefore the braking forces in the normal system can be maintained. For example, if the opening malfunction has occurred in the communication valve 26P, the hydraulic pressures in the wheel cylinders 8a and 8d connected to the primary system side reduce but the hydraulic pressures in the wheel cylinders 8b and 8c connected to the secondary system side can be maintained.

The system in which the hydraulic pressures reduce can be detected by the wheel cylinder pressure sensors 92P and 92S. Therefore, even if the hydraulic pressures reduce, pressure accumulation is performed by opening the communication valve 26P or the communication valve 26S, closing the pressure adjustment valve 27, and driving the pump 7 again in the system in which the hydraulic pressures reduce. The brake apparatus 1 is configured to include double systems in this manner, and therefore can increase the pressures again. Further, if the pressure re-increase happens many times, this can lead to detection of the malfunction in the communication valve 26. Therefore, the present configuration can improve malfunction detectability while ensuring the reliability of holding the hydraulic pressures, and can also reduce power consumption by an amount corresponding to the current for driving the pressure adjustment valve 27 in normal cases, thereby providing an advantage in a power saving performance.

[Effect]

(12) The pressure adjustment valve 27 is the normally-opened electromagnetic valve. The hydraulic holding portion 107 controls the pressure adjustment valve 27 in the valve-closing direction and then controls the pressure adjustment valve 27 in the valve-opening direction.

Therefore, the second embodiment can achieve the power saving.

### Third Embodiment

In a third embodiment, the brake hydraulic circuit is different from the first embodiment. In the following description, a brake apparatus 1a according to the third embodiment will be described, but a similar configuration to the first embodiment will be indicated by the same reference numeral and a description thereof will be omitted.

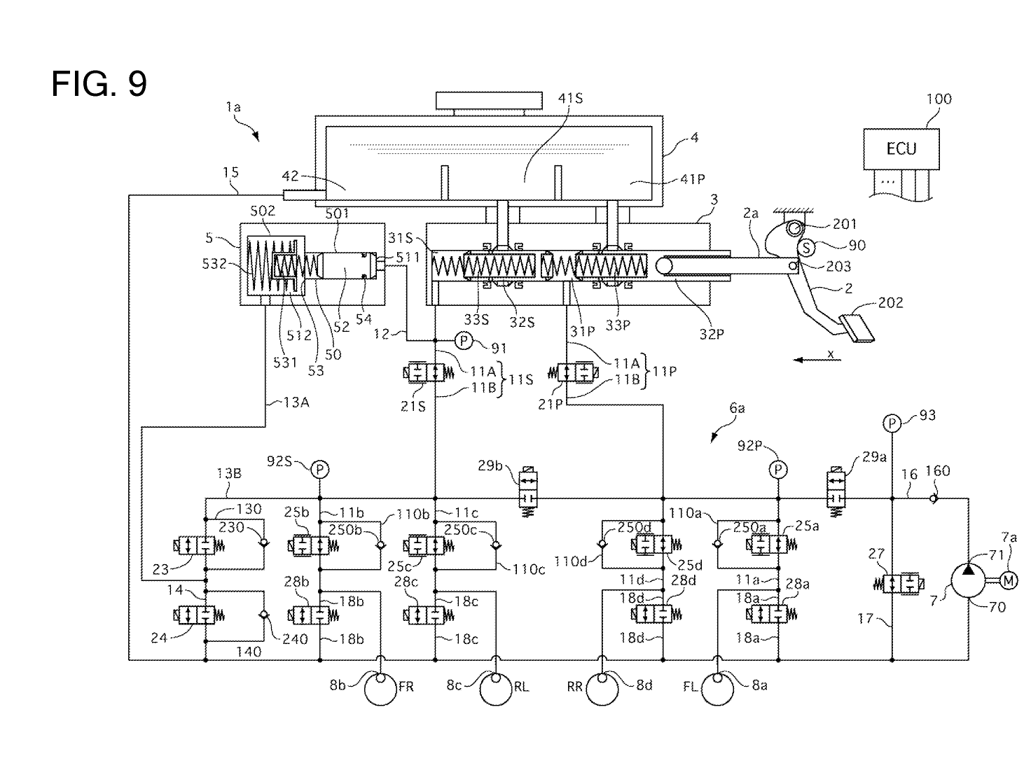

FIG. 9 schematically illustrates a configuration including a hydraulic circuit regarding the brake apparatus 1a according to the third embodiment. In a hydraulic control unit 6a, the discharge oil passage 16 of the pump 7 is connected to the first oil passage 11B (11P) of the primary system via an output communication valve 29a. The output communication valve 29a is a normally-closed electromagnetic valve. The first oil passage 11B (11P) of the primary system and the first oil passage 11B (11S) of the secondary system are configured in such a manner that the establishment and the block of the communication therebetween can be selected by a system communication valve 29b. The system communication valve 29b is a normally-closed electromagnetic valve. The destination to which the discharge oil passage 16 of the pump 7 is connected via the output communication valve 29a may be the first oil passage 11B (11S) of the secondary system.

At the time of the normal brake, the shut-off valves 21 are controlled in the valve-closing directions, the communication valves 29 are controlled in valve-opening directions, and the pressure adjustment valve 27 is controlled in the valve-closing direction. Along therewith, the pump 7 is activated. Controlling the actuators in this manner allows the desired brake fluid to be transmitted from the reservoir tank 4 side to the wheel cylinders 8 via the intake oil passage 15, the pump 7, the discharge oil passage 16, and the first oil passages 11. The brake fluid discharged from the pump 7 flows into the first oil passages 11B via the discharge oil passage 16. The pressure in each of the wheel cylinders 8 is increased due to an inflow of this brake fluid into each of the wheel cylinders 8. In other words, the pressures in the wheel cylinders 8 are increased with use of the hydraulic pressures generated in the first oil passages 11B by the pump 7. At this time, the desired braking forces can be acquired by performing the feedback control on the number of rotations of the pump 7 and the valve-opening state (the opening degree or the like) of the pressure adjustment valve 27 so that the values detected by the wheel cylinder pressure sensors 92 approach Pw*. In other words, Pw can be adjusted by controlling the valve-opening state of the pressure adjustment valve 27 to leak the brake fluid from the discharge oil passage 16 or the first oil passages 11 to the intake oil passage 15 via the pressure adjustment valve 27 as appropriate. The stroke simulator 5 operates in a similar manner to the first embodiment.

When the control for holding the hydraulic pressures in the wheel cylinders 8 is performed, the output communication valve 29a serves as an electromagnetic valve separating the discharge oil passage 16 and the oil passages connected to the wheel cylinders 8. Closing the output communication valve 29a after stopping the motor 7a allows the brake fluid to be confined in the first oil passages 11B and the wheel cylinders 8 enclosed by the shut-off valves 21 and the output communication valve 29a, thereby allowing the hydraulic pressures to be held. At this time, keeping the pressure adjustment valve 27 closed allows the output communication valve 29a and the pressure adjustment valve 27 to doubly block the oil passage for the brake fluid in the first oil passages 11B and each of the wheel cylinders 8, thereby improving the reliability of holding the wheel cylinder pressures.

Further, in the case where the pressure adjustment valve 27 is opened for the purpose of power saving at the time of the control for holding the hydraulic pressures in the wheel cylinders 8, the output communication valve 29a and the system communication valve 29b are closed. This doubly blocks the oil passage for the first oil passage 11B (11S) and the wheel cylinders 8b and 8c of the secondary system. If the opening malfunction has occurred in the output communication valve 29a, the hydraulic pressures in the wheel cylinders 8a and 8d of the primary system reduce but the hydraulic pressures in the wheel cylinders 8b and 8c of the secondary system can be held.

### Fourth Embodiment

In a fourth embodiment, the brake hydraulic circuit is different from the third embodiment. In the following description, a brake apparatus 1b according to the fourth embodiment will be described, but a similar configuration to the first or third embodiment will be indicated by the same reference numeral and a description thereof will be omitted.

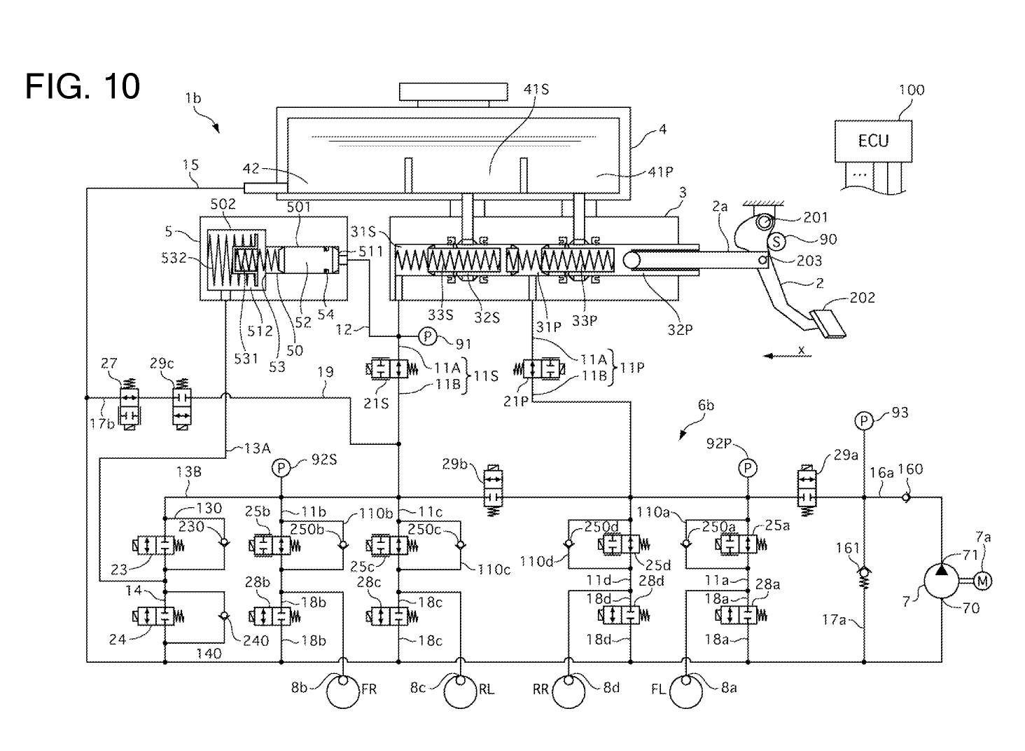

FIG. 10 schematically illustrates a configuration including a hydraulic circuit regarding the brake apparatus 1a according to the fourth embodiment. A hydraulic control unit 6b forms a return flow oil passage 17a from a discharge oil passage 16a of the pump 7, and a relief valve 161 is provided therein. The relief valve 161 is a one-way valve that permits an outflow of the oil from the discharge oil passage 16a to the return oil passage 17a only when the output of the pump 7 is a predetermined output (for example, 20 MPa) or larger. The discharge oil passage 16a is an oil passage used solely for outputting the brake fluid, and the brake fluid output from the pump 7 can be transmitted to the first oil passages 11 if the output communication valve 29a is opened.

An oil passage 19 branching off from the first oil passages 11B is formed. The oil passage 19 is connected to a first pressure reduction oil passage (return flow oil passage) 17b. A pressure adjustment communication valve 29c and the pressure adjustment valve 27 are provided between the oil passage 19 and the first pressure reduction oil passage 17b. The pressure adjustment communication valve 29c is a normally-closed electromagnetic valve. The hydraulic pressures in the first oil passages 11 are adjusted by opening the pressure adjustment communication valve 29c and proportionally controlling the pressure adjustment valve 27.

When the operation for holding the hydraulic pressures in the wheel cylinders 8 is performed, closing the output communication valve 29a and the pressure adjustment communication valve 29c after stopping the motor 7a allows the brake fluid to be confined in the first oil passages 11B and the wheel cylinders 8 enclosed by the shut-off valves 21, the output communication valve 29a, and the pressure adjustment communication valve 29c, thereby allowing the hydraulic pressures to be held.

### Fifth Embodiment

In a fifth embodiment, the brake hydraulic circuit is different from the first embodiment. In the following description, a brake apparatus 1c according to the fifth embodiment will be described, but a similar configuration to the first embodiment will be indicated by the same reference numeral and a description thereof will be omitted.

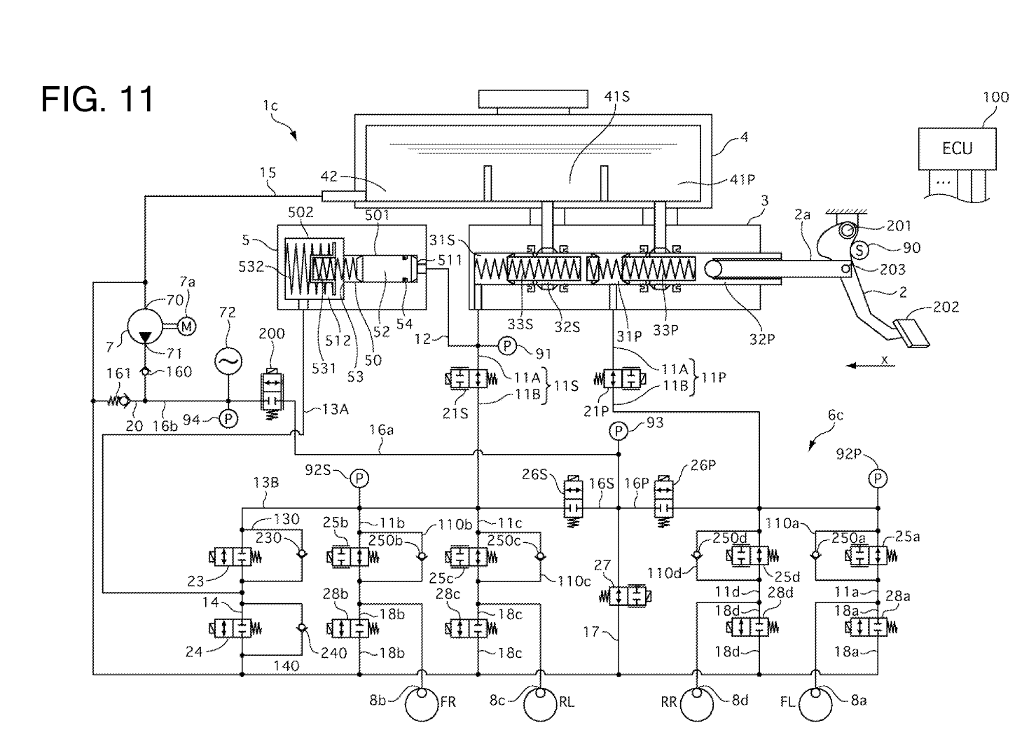

FIG. 11 schematically illustrates a configuration including a hydraulic circuit regarding the brake apparatus 1c according to the fifth embodiment. A hydraulic control unit 6c includes an accumulator 72 provided in a discharge oil passage 16b of the pump 7. The discharge oil passage 16b is connected to the discharge oil passage 16a via a pressure increase proportional valve 200. The pressure increase proportional valve 200 is a normally-closed proportional control valve. A relief valve 161 is provided in an oil passage 20 connected from the discharge oil passage 16b to the intake oil passage 15. The relief valve 161 is a one-way valve that permits an outflow of the oil from the discharge oil passage 16a to the intake oil passage 15 only when the output of the pump 7 is a predetermined output (for example, 20 MPa) or larger.

The pump 7 plays a sole role of accumulating energy into the accumulator 72, and is controlled by an accumulator hydraulic sensor 94 provided in the discharge oil passage 16a in such a manner that a hydraulic pressure of the accumulator 72 is constantly kept at a predetermined value or larger. When the brake fluid is transmitted to the wheel cylinders 8, the brake fluid can be output by an appropriate flow amount by adjusting an opening degree of the pressure increase proportional valve 200. The brake fluid amount transmitted to the wheel cylinders 8 is adjusted based on the number of rotations (i.e., the discharge amount) of the pump 7 and the pressure adjustment valve 27 in the first to fourth embodiments, but is adjusted based on the adjustment of the opening degrees of the pressure increase proportional valve 200 and the pressure adjustment valve 27 in the present embodiment. In other words, the hydraulic source can be regarded as being embodied by the pump 7, the accumulator 72, and the pressure increase proportional valve 200.

When the operation for holding the hydraulic pressures in the wheel cylinders 8 is performed, closing the pressure increase proportional valve 200 to stop the supply from the hydraulic source and closing the communication valves 26 allows the brake fluid to be confined in the first oil passages 11B and the wheel cylinders 8 enclosed by the shut-off valves 21 and the communication valves 26, thereby allowing the hydraulic pressures to be held.

### Other Embodiments

Having described embodiments for implementing the present invention based on the exemplary embodiments thereof, the specific configuration of the present invention is not limited to the exemplary embodiments, and the present invention also includes a design modification and the like thereof made within a range that does not depart from the spirit of the present invention. The hydraulic control unit may be an integrated unit integrally including the master cylinder 3, the hydraulic control unit 6, and the stroke simulator 5. Alternatively, the hydraulic control unit may be formed by a plurality of units in which any of the master cylinder 3, the hydraulic control unit 6, and the stroke simulator 5 is further divided.

In the first to fifth embodiments, the hydraulic wheel cylinder 8 is provided for each of the wheels, but the present invention is not limited thereto and may be configured to include, for example, the hydraulic wheel cylinder on the front wheel side and a caliper capable of generating the braking force with use of an electric motor on the rear wheel side.

Further, the control for holding the hydraulic pressures in the wheel cylinders 8 is not limited to being performed when the vehicle is determined to be stopped and the request to hold the hydraulic pressures is issued, but may be set so as to be performed in a case where no problem would arise even if the hydraulic pressures are held when the control hydraulic pressure is kept constant (for example, when the hydraulic pressure requested by the driver is kept constant or the instruction value from the automatic brake is kept constant).

Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2015-135720 filed on Jul. 7, 2015. The entire disclosure of Japanese Patent Application No. 2015-135720 filed on Jul. 7, 2015 including the specification, the claims, the drawings, and the abstract is incorporated herein by reference in its entirety.

### REFERENCE SIGN LIST

3 master cylinder
7 pump (hydraulic source)
8 wheel cylinder
11 first oil passage (second oil passage)
11P first oil passage (primary system oil passage)
11S first oil passage (secondary system oil passage)
16 discharge oil passage (first oil passage, connection oil passage)
17 first pressure reduction oil passage (return flow oil passage, pressure adjustment oil passage)
21 shut-off valve
26 communication valve (first valve)
26P communication valve (first communication valve)
26S communication valve (second communication valve)
27 pressure adjustment valve
31P primary hydraulic chamber
31S secondary hydraulic chamber
107 hydraulic holding portion
160 check valve (discharge valve)

20.-38. (canceled)

39. A brake control apparatus comprising:
a hydraulic source configured to supply brake fluid to a wheel cylinder;
a first oil passage connecting the hydraulic source and the wheel cylinder to each other;
a first valve provided in the first oil passage;
a return flow oil passage connected to the first oil passage between the hydraulic source and the first valve, and configured to return the brake fluid supplied from the hydraulic source to a low-pressure portion;
a pressure adjustment valve provided in the return flow oil passage, and configured to adjust a brake hydraulic pressure in the first oil passage;
a hydraulic holding portion configured to hold a hydraulic pressure in the wheel cylinder set by a brake hydraulic pressure supplied from the hydraulic source to the wheel cylinder by activating the pressure adjustment valve and the first valve in respective valve-closing directions; and
a vehicle stop state determination portion configured to determine a stop of a vehicle,
wherein the hydraulic source includes a pump, and
wherein the pump is stopped after the vehicle stop state determination portion determines that the vehicle is stopped.

40. The brake control apparatus according to claim 39, wherein the hydraulic holding portion holds the hydraulic pressure in the wheel cylinder after the vehicle stop state determination portion determines that the vehicle is stopped.

41. The brake control apparatus according to claim 40, wherein the pump includes a discharge valve configured to permit only a flow in a discharge direction.

42. The brake control apparatus according to claim 41, wherein the first valve and/or the pressure adjustment valve is/are closed after the pump is stopped.

43. The brake control apparatus according to claim 40, wherein the first valve and the pressure adjustment valve are electromagnetic valves, and
wherein at least one of the electromagnetic valves is a normally-closed valve.

44. The brake control apparatus according to claim 40, wherein the pressure adjustment valve is a normally-opened electromagnetic valve, and
wherein the hydraulic holding portion controls the pressure adjustment valve in the valve-closing direction and then controls the pressure adjustment valve in a valve-opening direction.

45. The brake control apparatus according to claim 44, further comprising:
a second oil passage connecting a position in the first oil passage that is located between the first valve and the wheel cylinder, and a master cylinder to each other; and
a shut-off valve provided in the second oil passage,
wherein the hydraulic holding portion holds the hydraulic pressure in the wheel cylinder by activating the shut-off valve in a valve-closing direction.

46. The brake control apparatus according to claim 40, wherein the brake control apparatus is mounted on the vehicle,
wherein the wheel cylinder includes a plurality of wheel cylinders,
wherein the brake control apparatus includes a first system including a plurality of first wheel cylinders among the plurality of wheel cylinders, and a second system including at least one second wheel cylinder, which is a remaining wheel cylinder or remaining wheel cylinders among the plurality of wheel cylinders,
wherein the first and second systems each include the first oil passage and the first valve, and
wherein the return flow oil passage is connected to a portion between the first valves of the first and second systems.

47. A brake control apparatus comprising:
a hydraulic source configured to supply brake fluid to a wheel cylinder;
a first oil passage connecting the hydraulic source and the wheel cylinder to each other;
a first valve provided in the first oil passage;
a pressure adjustment oil passage connected to the first oil passage between the hydraulic source and the first valve, and connected to a low-pressure portion;
a pressure adjustment valve provided in the pressure adjustment oil passage in series with the first valve;
a hydraulic holding portion configured to hold a hydraulic pressure in the wheel cylinder set by a brake hydraulic pressure supplied from the hydraulic source to the wheel cylinder by activating the pressure adjustment valve and the first valve in respective valve-closing directions; and
a vehicle stop state determination portion configured to determine a stop of a vehicle,
wherein the hydraulic source includes a pump, and
wherein the pump is stopped after the vehicle stop state determination portion determines that the vehicle is stopped.

48. The brake control apparatus according to claim 47, wherein the pump is stopped before the hydraulic holding portion is activated.

49. The brake control apparatus according to claim 47, wherein the hydraulic holding portion holds the hydraulic pressure in the wheel cylinder after the vehicle stop state determination portion determines that the vehicle is stopped.

50. The brake control apparatus according to claim 47, wherein the pump includes a discharge valve configured to permit only a flow in a discharge direction, and
wherein the pump is stopped before the hydraulic holding portion starts holding the hydraulic pressure in the wheel cylinder.

51. The brake control apparatus according to claim 50, wherein the first valve and the pressure adjustment valve are electromagnetic valves, and
wherein at least one of the electromagnetic valves is a normally-closed valve.

52. The brake control apparatus according to claim 51, wherein the pressure adjustment valve is a normally-opened electromagnetic valve, and
wherein the hydraulic holding portion controls the pressure adjustment valve in the valve-closing direction and then controls the pressure adjustment valve in a valve-opening direction.

53. The brake control apparatus according to claim 47, further comprising:
a second oil passage connecting a position in the first oil passage that is located between the first valve and the wheel cylinder, and a master cylinder to each other; and
a shut-off valve provided in the second oil passage,
wherein the hydraulic holding portion holds the hydraulic pressure in the wheel cylinder by activating the shut-off valve in a valve-closing direction.

54. A brake system comprising:
a master cylinder including a primary hydraulic chamber configured to supply a hydraulic pressure to a wheel cylinder belonging to a primary system provided to a vehicle, and a secondary hydraulic chamber configured to supply a hydraulic pressure to a wheel cylinder belonging to a secondary system;
a primary system oil passage connecting the primary hydraulic chamber and the wheel cylinder belonging to the primary system to each other;
a secondary system oil passage connecting the secondary hydraulic chamber and the wheel cylinder belonging to the secondary system to each other;
a connection oil passage connecting the primary system oil passage and the secondary system oil passage to each other;
a hydraulic source connected to the connection oil passage, and configured to supply brake fluid to the corresponding wheel cylinder via each of the primary and second system oil passages;
a first communication valve provided between the connection oil passage and the primary system oil passage;
a second communication valve provided between the connection oil passage and the secondary system oil passage;
a pressure reduction oil passage connecting the connection oil passage and a low-pressure portion to each other;
a pressure adjustment valve provided in the pressure reduction oil passage;
a hydraulic holding portion configured to hold a brake hydraulic pressure supplied from the hydraulic source to the corresponding wheel cylinder by controlling each of the first and second communication valves and the pressure adjustment valve in respective valve-closing directions; and
a vehicle stop state determination portion configured to determine a stop of a vehicle,
wherein the hydraulic source includes a pump, and
wherein the pump is stopped after the vehicle stop state determination portion determines that the vehicle is stopped.

55. The brake system according to claim 54, wherein the hydraulic holding portion holds the hydraulic pressure in the corresponding wheel cylinder after the vehicle stop state determination portion determines that the vehicle is stopped.

56. The brake system according to claim 55, wherein the pump includes a discharge valve configured to permit only a flow in a discharge direction,
wherein the hydraulic pressure in each of the wheel cylinders belonging to the primary system and the secondary system is increased by the brake fluid discharged from the pump, and
wherein the pump is stopped before the hydraulic holding portion starts holding the hydraulic pressure in the corresponding wheel cylinder.

57. The brake system according to claim 56, wherein the pressure adjustment valve is a normally-opened electromagnetic valve, and
wherein the hydraulic holding portion controls the pressure adjustment valve in the valve-closing direction and then controls the pressure adjustment valve in a valve-opening direction.
